(19) United States
(12) Patent Application Publication
(10) Pub. No.: US 2009/0030707 A1
(43) Pub. Date: Jan. 29, 2009

(54) SYSTEM AND METHOD OF RESEARCHING REAL ESTATE

(75) Inventor: Ido Green, Menlo Park, CA (US)

Correspondence Address: Yahoo! Inc., c/o Kenyon & Kenyon LLP, 333 W. San Carlos Street, Suite 600, San Jose, CA, 95110, US

(73) Assignee: YAHOO! INC., Sunnyvale, CA (US)

(21) Appl. No.: 11/781,578

(22) Filed: Jul. 23, 2007

(51) Int. Cl. G06Q 99/00

(52) U.S. Cl. 705/1

(57) ABSTRACT

A method of researching real estate properties online uses a local Rich Internet Application (RIA) to perform an online search through a real estate web service and stores the results of the search locally so that they may be accessed offline. The results of the search may be further used by a map web service to generate maps of, and driving directions between, selected properties, and this information may also be stored locally for offline retrieval.

### BACKGROUND

1. Field of the Invention

Aspects of the present invention relate generally to the use of a desktop application to search for, browse, and map various real estate properties of interest through web services, while allowing the user to access previous searches and interactions with the web application even when offline.

2. Description of Related Art

As is known in the art, a Rich Internet Application (RIA) is one that runs locally (e.g., within the user's browser) but interacts with a remote service. These remote services, available through the Internet, are more generally known as web services, and it is common for them to essentially be extensions of “web applications” already accessible through a web browser. Web applications may include any of a number of tools, such as search, web mail, instant messaging, information syndication (e.g., RSS), etc. Web services generally allow users to take advantage of web applications while abstracting them away from the usual web browser paradigm. Such access provides various opportunities to “exploit” the web applications' resources to improve the user's overall experience and allow for the creation of new services on top of those already available.

It is through web services that RIAs usually operate, and because the RIAs are local and are not necessarily bound by the traditional client/server architecture, they tend to bypass the usual interaction loop and take on more of the processing requirements, thereby allowing for “richer” manipulation of data than may otherwise be possible. One of the technologies used to provide this type of experience is Asynchronous JavaScript and XML (Ajax), which enables RIAs (and web pages generally) to interact with web sites asynchronously (i.e., behind-the-scenes, outside of the usual page-loading process); because Ajax allows for parts of a page to be loaded in the background each time new data is requested, the interaction between the RIA and the web application can feel much more responsive than it otherwise would.

Generally, RIAs are made possible through web Application Programming Interfaces (APIs) provided by the web applications, without which it would be much more difficult, or even impossible in some cases, to interact with the web application outside of the web browser interface provided by the application.

The operation and purpose of web APIs are well known in the art. Briefly, however, and much like any API, a web API is an interface to some service running on a remote system and accessed over a network. Various, sometimes overlapping, methods and protocols exist for implementing web APIs, such as, for example, Simple Object Access Protocol (SOAP), Representative State Transfer (REST), XML-RPC, etc., and most use variations of Extensible Modeling Language (XML) data formats for messaging (i.e., transferring data between the web service and the local application).

While RIAs may be implemented within a web browser, they also may exist as completely stand-alone applications—local [desktop] applications capable of talking to, and interacting with, web applications. While there are various frameworks and platforms specifically designed for RIAs (e.g., Adobe's™ Apollo, etc.), they can also be constructed using traditional programming languages, such as, for example, Java™, C++, etc.

There currently are web sites/applications available for searching real estate properties (e.g., Yahoo! Real Estate, etc.), mapping the locations of those properties, and generating driving directions to and from those properties (e.g., Yahoo! Maps, etc.). However, these sites are inherently limited by the requirement that they present the property data in a format conducive to their display and manipulation within a web browser. Given the open APIs that these and similar sites often provide, it is possible to develop an RIA that can automate some of the manual legwork the user might otherwise be required to perform (e.g., when he wishes to create a driving route between two or more properties) and can provide the user with a better overall experience. Moreover, such an RIA may use a local database to store the data it has received through the web APIs, thereby allowing the user to take advantage of the research he has already conducted, even when he has no current access to the web service(s).

Thus, it would be desirable to use a desktop RIA to search for real estate online. It would also be desirable to make previous searches and interactions with the web service(s) available offline so that a user may continue to use the results even when unable to connect to the web service(s).

### SUMMARY

In light of the foregoing, it is a general object of the present invention to provide a useful and novel way of bringing together, in an RIA, disparate services used in searching for real estate online, and to provide the user with a richer experience than can be had through the traditional method of interacting with web applications through a web browser.

It is another object of the invention to make previous searches and interactions available to the user even when he is unable to connect to the web service(s).

### BRIEF DESCRIPTION OF THE DRAWING FIGURES

FIG. 1 is a functional block diagram of the general architecture of an exemplary embodiment of the present invention.

FIG. 2 is a logical flowchart of the general process by which an exemplary RIA provides real estate research functionality.

FIG. 3 is a drawing of an exemplary real estate research RIA.

### DETAILED DESCRIPTION

Detailed descriptions of one or more embodiments of the invention follow, examples of which may be graphically illustrated in the drawings. Each example and embodiment is provided by way of explanation of the invention, and is not meant as a limitation of the invention. For example, features described as part of one embodiment may be utilized with another embodiment to yield still a further embodiment. It is intended that the present invention include these and other modifications and variations.

Aspects of the present invention are described below in the context of extending real estate web applications from the web browser to the desktop.

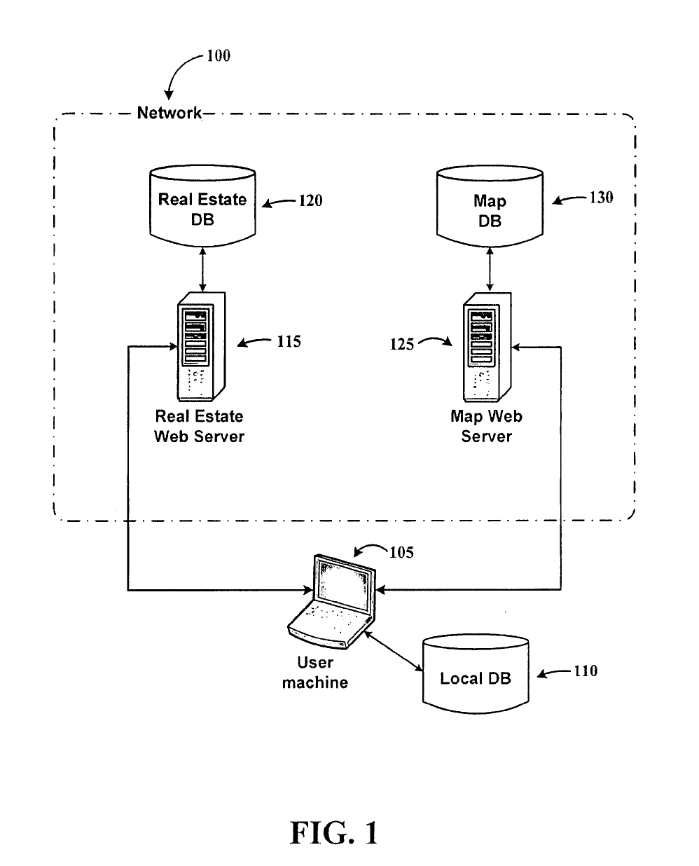

FIG. 1 is a functional block diagram of the general architecture of an exemplary embodiment of the present invention. All of the system elements are on a network 100 (e.g., the Internet) and each interfaces with a user computer 105 over the network 100 through various protocols, such as, for example, the HyperText Transfer Protocol (HTTP), the protocols required by the web APIs provided by the respective applications running on the various servers, etc. Real Estate Web Server 115 is the server(s) that responds to real estate searches from a web browser, an RIA, etc. Much like any web server, this server may receive requests, process them, and then provide the user with the results of the requests. Real Estate DB 120 is the database(s) providing data needed by the applications running on the Real Estate Web Server 115 (e.g., Yahoo!™ Real Estate, etc.). Similarly, Map Web Server 125 and Map DB 130 serve their respective functions in much the same way as Real Estate Web Server 115 and Real Estate DB 120, except that the web application running on the Map Web Server 125 is generally related to geographic and directional information.

Local DB 110 is a database that resides on the user's local machine and stores data received by an RIA during the user's interaction with it; such a database may be implemented using any database application (e.g., MySQL, BerkeleyDB, JavaDB, etc.) capable of being written to and read from by an RIA. Those skilled in the art will appreciate that “local” does not necessarily mean physically within the user computer 105; it is possible for the Local DB 110 to be implemented in a medium other than an internal hard drive, such as, for example, a Universal Serial Bus (USB) mass storage (flash memory, hard disk drive, etc.) dongle, etc.

Some of the various platforms and frameworks available for RIA development include databases, or, at least native APIs for interfacing with various databases. In one embodiment, both an RIA and a database may be part of the same downloadable package, thereby providing the end user with a simple, practical solution to interfacing with the web application(s) outside of the web browser. For example, using Sun's Java™ Web Start technology, standalone Java applications, bundled with a database (e.g., JavaDB, etc.), may be automatically downloaded over the network 100 through a web browser and installed on the user's local computer 105, with little to no effort from the user.

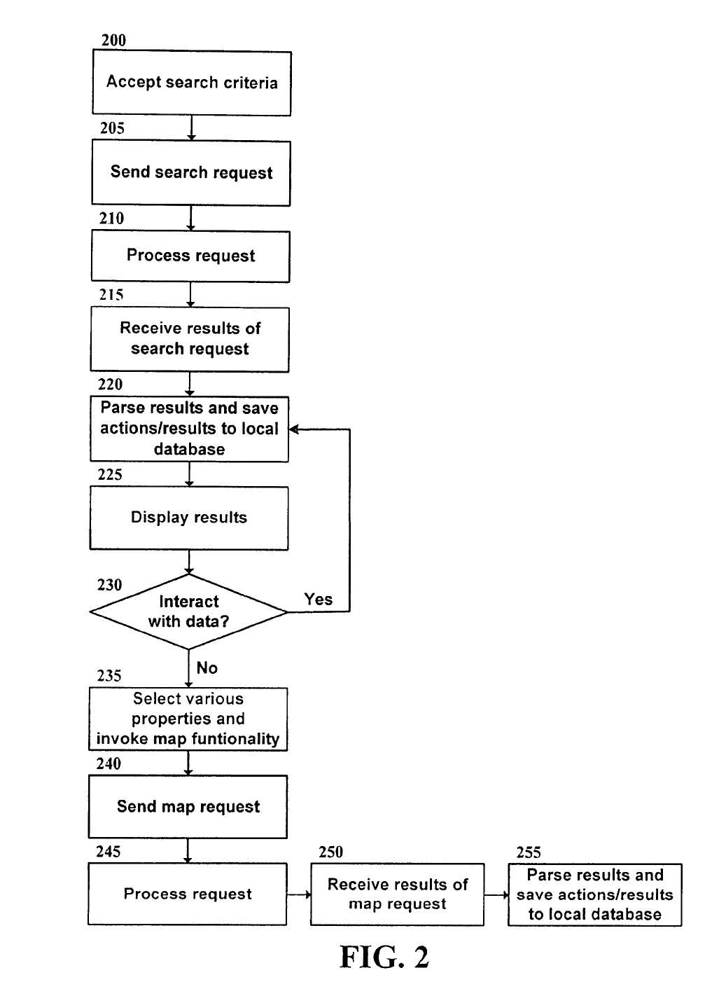

FIG. 2 provides a flowchart of the general process by which an exemplary RIA running on user computer 105 provides real estate research functionality by leveraging the services offered by Real Estate Web Server 115 and Map Web Server 125. Similarly to a web site used to search for real estate, the RIA may have a search mechanism 305 through which the user can search for a particular property using any number of criteria, where such criteria is limited only by the API supplied by the respective web service. At block 200, the user enters search criteria into the RIA. At block 205, the RIA puts the search criteria into a format understandable by the API and then sends it off to the Real Estate Web Server 120, which processes the search request at block 210 and then sends the results of the search back to the RIA at block 215. Depending on the particular search being run and the capabilities of the RIA, the back-and-forth interaction between the RIA and the Real Estate Web Server 120 may involve more than a single send/receive transaction. For example, the RIA may offer a search feature not available through the web site interface, which may require more than one invocation of the search that is available through the web site. In that case, the RIA may send the first search to the Real Estate Web Server 120, receive the results, and then use elements of those results in a second search before finally displaying the ultimate results to the user, as discussed below.

At block 220, the RIA receives the results from the Real Estate Web Server 120. Upon receiving the data, the RIA parses the results and saves the data to the Local DB 110. The information saved to the database may include not only the data received by the RIA from the Real Estate Web Server 115, but also the actual actions taken by the user since data was last received from a web service (e.g., the search terms that produced the received data, etc.). By saving these actions and results, the user can later return to them when he is without a connection to the various servers, such as, for example, when traveling between potential properties; by mirroring to the local DB 110 everything he does, and receives, through the RIA, he can bring his laptop along during the trip, instead of printing everything out on paper.

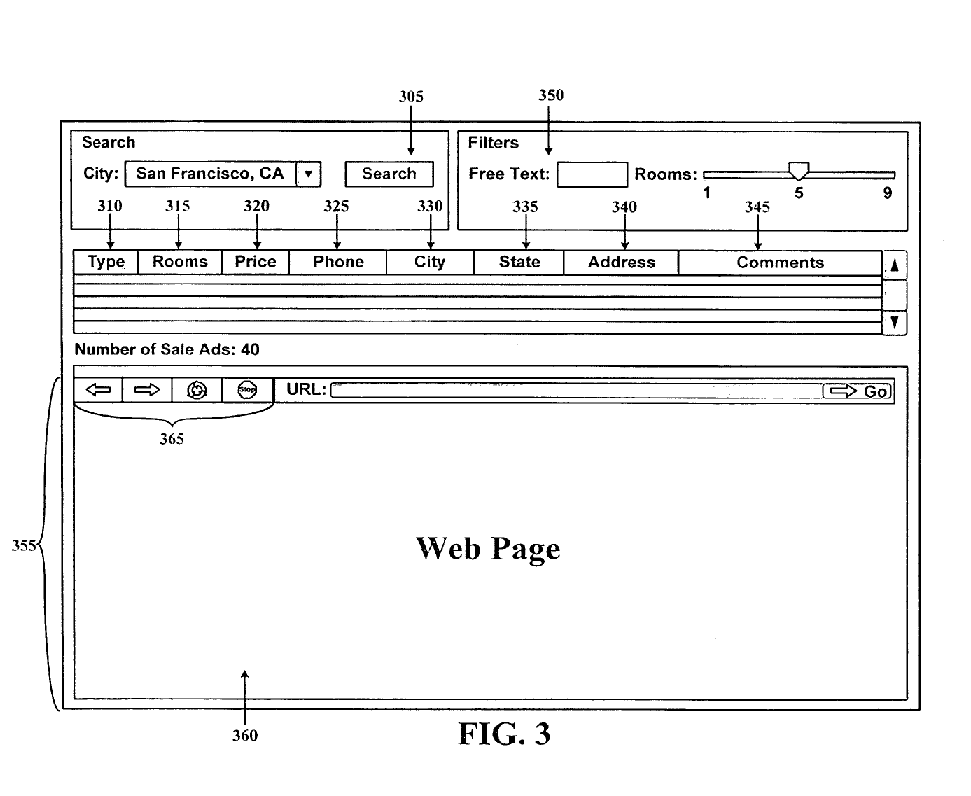

The received data is presented to the user at block 225; such data can be displayed and manipulated in various ways at block 230, and because the RIA is not necessarily constrained by the requirements of a web browser, it can show the user the data in forms that may be more useful. In addition, because all of the data is now local to the user, data manipulation is faster (i.e., the request does not have to be sent to the server, processed there, and then sent back to the user). Some of these display/manipulatory options may include listing the properties in a multi-column format, where each column corresponds to one of any of the data elements sent from the Real Estate Web Server 115. As shown in FIG. 3, these data elements may include (but are not limited to) the type of property 310, number of rooms 315, price 320, phone number 325, city 330, state 335, address 340, comments 345, etc., for a particular property. An analogy might be made to Windows'™ Explorer or Macintosh's™ Finder, where the user is given a multi-column window and where the columns contain information like file name, modification date, creation date, etc. The user can choose any of the columns to use as the sort “key,” and may further choose to sort the column in ascending or descending order (or similar depending on the type of data contained in the column), etc.

In one embodiment, the RIA may also include a filter mechanism 350 for searching within the results. For example, upon receiving the search results, the user may wish to further pare them down by searching through the comments left by the sellers of the various properties. As another example, the user may wish to search for a particular street name. Other manipulatory tools may also be included, such as, for example, a “slider” to specify the number of rooms desired by the user.

In another embodiment, the RIA may include a web browser engine 355 to give the user all of the data he might otherwise see if he were to search from the web site instead of through the RIA. Such functionality may also serve the purpose of keeping the particular web site's traffic numbers up; depending on how the site monitors its web traffic, hits by the RIA through a web service may not register as hits on the web site. This information, like everything else, may be saved to the Local DB 110 so that it may be accessed later when the user does not have a connection to the network 100. Such web browser engine functionality may include the ability to “browse” through the site, but within the RIA. For example, the RIA may list the various properties (as described above), and, when the user selects one of the properties, display the actual web page 360 for that property as it is normally served by the Real Estate Web Server 115. Once the page is rendered within the RIA, the user may then interact with it using browser controls 365 as if it were within a regular web browser (i.e., click on links, go forward/back, etc.) and all actions and web page data are saved to the Local DB 110.

In yet another embodiment, the RIA may include an image “viewer” for interacting with the various images associated with a property. As part of the data it supplies, the real estate web service may provide either actual images of the respective property or network addresses that correspond to the images (e.g., by using a Universal Resource Indicator, or URI). In either case, the image viewer may allow the user to view the referenced images and manipulate them in meaningful ways (e.g., zoom into a picture, annotate an image, etc).

In still another embodiment, the RIA may include a calculator for deducing the various costs involved with buying or renting a particular property. To the extent relevant information is provided by the real estate web service (e.g., cost, rental term, minimum down payment required, etc.), such information can automatically populate the respective fields required by the calculator, and, together with the user's particular financial reservations (e.g., user will not purchase the home if the monthly mortgage payment is more than some threshold amount, etc.), the calculator can return to the user useful information.

As shown by block 235 of FIG. 2, the RIA can “map” the various properties, where such mapping functionality is provided by a web service that corresponds to any of a number of map web applications (e.g., Yahoo! Maps™, etc.). When the user is done manipulating and interacting with the data at block 230, he may choose, at block 235, those properties he is most interested in and would like to research further, thereby creating a “subset” of the properties originally retrieved at block 215. Obviously the “subset” can include some or all of the originally retrieved properties. The RIA can use data already provided by the previous real estate search (i.e., the addresses of the various properties) to build requests for the map web service. After selecting these various properties, the user may invoke the RIA's map functionality (e.g., through a “button” provided by the RIA, a tab, etc.), at which point the map request is put into a format understandable by the respective web API and sent to the Map Web Server 125 at block 240. The Map Web Server 125 processes the request at block 245, and then sends the results of the request to the RIA at block 250. At block 255, the RIA parses the results and saves the data to the Local DB 110.

The mapping information returned by the Map Web Server 125 may include a number of things, depending on the user's desires, the functionality built into the RIA, and the limitations of the map web service. For example, the RIA may store the user's home address and then request the map web service to return the respective routes between the user's home and each of the properties he selected. Similarly, if more than one property is selected, the RIA may use the web service to generate a route from the user's home to each selected property and then back to the user's home, so as to create a closed loop that touches each of the properties (i.e., user's home→property 1→property 2→user's home). Also, much like interactions with the real estate web service, the RIA may include web browsing functionality; in that case, the user may see the map information for a particular property as if he had accessed the map application outside of the RIA and through his regular web browser, and all of the usual map functionality (i.e., whatever functions the map application supports) would be available to the user (e.g., zoom in/out, satellite view, etc.).

Finally, and as explained above, all actions respecting, and data received from, the map web service are stored to the Local DB 110 for future offline use (e.g., when the user is accessing the closed-loop driving route on his laptop as he visits various properties).

The sequence and numbering of blocks depicted in FIG. 2 is not intended to imply an order of operations to the exclusion of other possibilities. It will be appreciated by those of skill in the art that the foregoing systems and methods are susceptible of various modifications and alterations. For example, directly before sending the search request at block 205, the search criteria may be saved to the local DB instead of waiting for the RIA to act on any returned results at block 220. As another example, the RIA may be capable of providing the user with up-to-date search information by constantly re-running, in the background, the last few searches the user has performed.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A method of researching real estate properties online; said method comprising:
responsive to first search criteria, performing a first online search on a real estate web service to retrieve first data associated with a plurality of real estate properties;
responsive to second search criteria, performing a further online search on the first data to retrieve second data associated with a subset of the plurality of real estate properties; and
storing the first and second data locally to enable searching and retrieval of the first or said second data offline.

2. The method of claim 1 wherein the subset of the plurality of real estate properties is the plurality of real estate properties.

3. The method of claim 1 wherein the first data comprises, for one or more properties in the plurality of real estate properties, data selected from the group consisting of type of property, number of rooms, price, phone number, city, state, address, images of the property, and comments about the property.

4. The method of claim 1 further comprising selectively ordering the first or second data.

5. The method of claim 4 wherein said selectively ordering comprises filtering the first or second data according to one or more predetermined criteria.

6. The method of claim 5 wherein, for one or more properties in the plurality of real estate properties, said predetermined criteria are selected from the group consisting of type of property, number of rooms, price, phone number, city, state, address, and comments about the property.

7. The method of claim 1, wherein the second data comprises mapping data, received from a map web service, associated with the subset of the plurality of real estate properties.

8. The method of claim 7 wherein the mapping data comprises location data for each member of the subset of the plurality of real estate properties.

9. The method of claim 7 wherein the mapping data comprises directional information defining a respective route between a pre-determined start location and each member of the subset of the plurality of real estate properties.

10. The method of claim 7 wherein the mapping data comprises directional information defining a route between a pre-determined start location and all members of the subset of the plurality of real estate properties, thereby creating a closed-loop route comprising the subset of the plurality of real estate properties.

11. The method of claim 1 wherein the first data comprises web page information that corresponds to each of the plurality of real estate properties.

12. The method of claim 1 wherein the second data comprises web page information that corresponds to each member of the subset of the plurality of real estate properties.

13. A computer-readable medium encoded with a computer-executable program to perform a method comprising:
responsive to first search criteria, performing a first online search on a real estate web service to retrieve first data associated with a plurality of real estate properties;
responsive to second search criteria, performing a further online search on the first data to retrieve second data associated with a subset of the plurality of real estate properties; and
storing the first and second data locally to enable searching and retrieval of the first or said second data offline.

14. The computer-readable medium of claim 13 wherein the subset of the plurality of real estate properties is the plurality of real estate properties.

15. The computer-readable medium of claim 13 wherein the first data comprises, for one or more properties in the plurality of real estate properties, data selected from the group consisting of type of property, number of rooms, price, phone number, city, state, address, images of the property, and comments about the property.

16. The computer-readable medium of claim 13 further comprising selectively ordering the first or second data.

17. The computer-readable medium of claim 16 wherein said selectively ordering comprises filtering the first or second data according to one or more predetermined criteria.

18. The computer-readable medium of claim 17 wherein, for one or more properties in the plurality of real estate properties, said predetermined criteria are selected from the group consisting of type of property, number of rooms, price, phone number, city, state, address, and comments about the property.

19. The computer-readable medium of claim 13, wherein the second data comprises mapping data, received from a map web service, associated with the subset of the plurality of real estate properties.

20. The computer-readable medium of claim 19 wherein the mapping data comprises location data for each member of the subset of the plurality of real estate properties.

21. The computer-readable medium of claim 19 wherein the mapping data comprises directional information defining a respective route between a pre-determined start location and each member of the subset of the plurality of real estate properties.

22. The computer-readable medium of claim 19 wherein the mapping data comprises directional information defining a route between a pre-determined start location and all members of the subset of the plurality of real estate properties, thereby creating a closed-loop route comprising the subset of the plurality of real estate properties.

23. The computer-readable medium of claim 13 wherein the first data comprises web page information that corresponds to each of the plurality of real estate properties.

24. The computer-readable medium of claim 13 wherein the second data comprises web page information that corresponds to each member of the subset of the plurality of real estate properties.
